(19) United States
(12) Patent Application Publication
(10) Pub. No.: US 2010/0215152 A1
(43) Pub. Date: Aug. 26, 2010

(54) Radiation imaging apparatus

(75) Inventor: Shoji Takahashi, Kanagawa-ken (JP)

Correspondence Address: AKERMAN SENTERFITT, 8100 BOONE BOULEVARD, SUITE 700, VIENNA, VA, 22182-2683, US

(73) Assignee: FUJIFILM Corporation, Tokyo (JP)

(21) Appl. No.: 12/659,133

(22) Filed: Feb. 26, 2010

(30) Foreign Application Priority Data
Feb. 26, 2009 (JP) 2009-043767
Aug. 24, 2009 (JP) 2009-192764

(51) Int. Cl. H05G 1/02

(52) U.S. Cl. 378/197

(57) ABSTRACT

A radiation imaging apparatus is equipped with: a radiation source; a radiation detector; an imaging element mounting portion on which the radiation source is mounted; an extending/contracting portion, capable of extending and contracting in a vertical Z direction, for holding the imaging element mounting portion; a horizontal driving section for moving the extending/contracting portion in each of the X and Y directions; a vertical driving section, for extending and contracting the extending/contracting portion; an inclination angle sensor, for detecting the inclination of the longitudinal axis of the extending/contracting portion with respect to gravity; and a control section, for obtaining an amount of positional shifting of the radiation source from a predetermined position, based on the inclination detected by the inclination angle sensor and the length of the extending/contracting portion, and for driving at least one of the driving sections in order to correct the positional shifting.

### BACKGROUND OF THE INVENTION

1. Field of the Invention

The present invention is related to a radiation imaging apparatus that irradiates radiation from a radiation source toward a subject, and detects the radiation which has passed through the subject with a radiation detecting means. More particularly, the present invention is related to a radiation imaging apparatus which is capable of correcting the positional relationship between the radiation source and the radiation detecting means.

2. Description of the Related Art

There are known radiation imaging apparatuses which are equipped with: a radiation source for irradiating radiation such as X rays toward a subject; and radiation detecting means for detecting the radiation which has passed through the subject (refer to Japanese Unexamined Patent Publication No. 2008-167948, for example). Note that silver salt photographic films, such as X ray film, radiation converting panels (stimulable phosphor sheets) such as that described in Japanese Unexamined Patent Publication No. 2008-167948, and solid state radiation detectors are known examples of the radiation detecting means.

A configuration has been proposed for this type of radiation imaging apparatus, in U.S. Pat. Nos. 6,435,716 and 7,641,391. In the proposed configuration, one or both of a radiation source, which is suspended from the ceiling of a room, and a radiation detecting means are capable of moving two dimensionally within horizontal planes as well as vertically, in order to improve the workability and efficiency of radiation imaging. In many cases, radiation imaging apparatuses having this configuration are constituted by: a pair of first rails that extend in a horizontal direction (Y direction) which is fixed to the ceiling; a Y axis runner portion that moves along the rail; a second rail that extends in a horizontal direction (X direction) perpendicular to the Y direction, which is fixed to the Y runner portion; an X axis runner portion that moves along the second rail; an extending/contracting portion, of which the length is variable, that extends downward (Z direction) from the X axis runner portion; and a radiation source or a radiation detecting means which is mounted on the extending/contracting portion.

In a radiation imaging apparatus equipped with the aforementioned radiation source and the radiation detecting means, it is necessary to position the radiation source and the radiation detecting means such that the direction of the irradiating axis of the radiation source faces a predetermined position (in many cases, the center position) of a detecting surface of the radiation detecting means. Note that hereinafter, a state in which proper positioning is not achieved will be referred to as “in plane positional shifting”.

In addition, there are cases in which the distance between a radiation source and an imaging surface (a radiation detecting surface) is determined according to radiation imaging conditions and the like. In these cases, it is necessary to accurately set the distance between the radiation source and the radiation detecting means such that the determined distance is secured. Note that hereinafter, the distance between the radiation source and the imaging surface will be referred to as SID (Source Image Distance).

However, there are cases in which the positioning of the radiation source and the radiation detecting means is not accurate (occurrence of in plane positional shifting), and cases in which the actual SID is shifted from a set SID. These problems are particularly likely to occur in radiation imaging apparatuses which are configured such that the radiation source or the radiation detecting means is moved while being suspended from ceilings of rooms. That is, the extending/contracting portion of this type of radiation imaging apparatus may become inclined, due to: fluctuations in the height positions of the ceiling, bowing/bending of the ceiling due to the weight of the runner portions; fluctuations in the mounting heights of the rails onto the ceiling; bending of the rails themselves; flexing of the rails due to the biased weight of X ray tubes and the like; flexing of the rails due to the weight of the runner portions; differences in flex of runner wheels due to uneven weights of the runner portions; bending of the surface of the runner portion onto which the extending/contracting portion is mounted; flexing of the extending/contracting portion due to the biased weight of X ray tubes and the like; bowing/bending of the parts that constitute the extending/contracting portion; and margins of error of the extending/contracting mechanism of the extending/contracting portion.

Further, in the case that an apparatus is constituted by: a pair of Y axis rails that extend in the Y direction; a Y axis runner portion that moves along the rail; an X axis rail that extends in a horizontal direction (X direction) perpendicular to the Y direction, which is fixed to the Y runner portion; and an X axis runner portion that moves along the second rail, an additional factor contributes to the inclination of the extending/contracting portion. That is, in this configuration, the X axis rail is held onto a first Y axis rail via the Y axis runner portion, which results in a solid hold with no margin of error. However, it is often the case that the X axis rail is held so as to be freely slidable with respect to a second Y axis rail. As a result, the X axis rail becomes more likely to be distorted at positions toward the second Y axis rail. If the X axis rail becomes distorted, the X axis runner mounted thereon becomes inclined, and consequently, the extending/contracting portion supported thereby also becomes inclined.

In addition, because the factors that result in the extending/contracting portion becoming inclined change over time. Therefore, there are cases in which the inclination becomes greater over time.

U.S. Pat. No. 6,435,716 discloses a method for accurately setting the SID to a desired value. In this method, so called solid exposure, in which radiation is irradiated onto the radiation detecting means without a subject, is performed twice with the radiation source at different positions. The irradiation field size on the radiation detecting means is detected at each exposure operation, and the relationship between the irradiation field size and the position of the radiation source is obtained. Thereafter, the position of the radiation source is determined based on the aforementioned relationship when a desired SID is to be set, to enable positioning that realizes accurate SID's.

However, the method for setting SID's disclosed in U.S. Pat. No. 6,435,716 exhibits the following problems.

(1) It is necessary to measure the positions by irradiating radiation onto the radiation detecting means in advance, and SID's for positions at which radiation was not irradiated are interpolated. Therefore, local shifting, such as those caused by flexing of rails, cannot be calibrated.
(2) Position data are obtained at the initial installation of the apparatus, and it is necessary to perform irradiation at a great number of positions.
(3) Because this method does not take flexing of rails and the like over time into consideration, the accuracy deteriorates over time. Irradiation at a great number of positions is necessary to recalibrate the SID's.
(4) Recalibration becomes necessary each time that X ray tubes and the like are exchanged, and irradiation at a great number of positions must be performed again.

With respect to problem (2) above, in the case that the radiation source moves through a 3 m by 5 m by 2 m space, and calibration is performed at 1 m intervals, 30 (3×5×2) to 48 (4×6×3) irradiating operations become necessary.

### SUMMARY OF THE INVENTION

The present invention has been developed in view of the foregoing circumstances. It is an object of the present invention to provide a radiation imaging apparatus equipped with an extending/contracting portion, which is capable of accurately correcting in plane positional shifting and SID's caused by inclinations of the extending/contracting portion, without performing irradiation of radiation.

It is another object of the present invention to provide a radiation imaging apparatus which is capable of preventing radiation imaging from being performed in a state that in plane positional shifting and inaccurate SID's are present.

A first radiation imaging apparatus of the present invention is capable of correcting in plane positional shifting and inaccurate SID's, and comprises:

a radiation source, for emitting radiation toward a subject;

a radiation detecting means, for detecting the radiation which has passed through the subject;

an imaging element mounting portion, on which one of the radiation source and the radiation detecting means is mounted;

an extending/contracting portion, which is extensible and contractible in a substantially vertical Z direction, for holding the imaging element mounting portion;

a guide mechanism, for holding the extending/contracting portion such that the extending/contracting portion is movable in at least one of an X direction and a Y direction, which are substantially horizontal and perpendicularly intersect the direction of extension and contraction of the extending/contracting portion;

a horizontal movement driving section, for moving the extending/contracting portion along the guide mechanism;

a vertical movement driving section, for causing the extending/contracting portion to extend and contract;

an inclination angle sensor, for detecting the inclination of the longitudinal axis of the extending/contracting portion with respect to the direction of gravity; and

control means, for obtaining an amount of positional shifting of one of the radiation detecting means and the radiation source, which is mounted on the imaging element mounting portion, from a predetermined position (the positional shifting includes both in plane positional shifting and an inaccurate SID), based on the inclination detected by the inclination angle sensor and the length of the extending/contracting portion, and for driving at least one of the horizontal movement driving section and the vertical movement driving section in order to correct the positional shifting.

The first radiation imaging apparatus according to a first aspect of the present invention may employ a guide mechanism that holds the extending/contracting portion so as to be movable in only one of the X direction and the Y direction. In this case, the imaging element mounting portion is capable of biaxial movement, along one horizontal axis and the vertical axis.

The first radiation imaging apparatus according to a second aspect of the present invention may employ a guide mechanism that holds the extending/contracting portion so as to be movable in both the X direction and the Y direction. In this case, a first driving section and a second driving section, for moving the extending/contracting portion in each of the X and Y directions, are provided as the horizontal movement driving section, a third driving section is provided as the vertical movement driving section, and the imaging element mounting portion is capable of triaxial movement, along two horizontal axes and the vertical axis.

In the case that the imaging element mounting portion of the first radiation imaging apparatus is capable of triaxial movement as described above, it is desirable for the control means to be configured to drive the first and second driving sections in a state in which the one of the radiation source and the radiation detecting means is mounted on the imaging element mounting portion with the direction of the radiation irradiating axis thereof (the radiation irradiating direction of the radiation source, or a line normal to a detecting surface of the radiation detecting means) substantially aligned with the longitudinal direction of the extending/contracting portion.

In addition, in the case that the imaging element mounting portion of the first radiation imaging apparatus is capable of triaxial movement as described above, it is desirable for the control means to be configured to drive the third driving section in a state in which the one of the radiation source and the radiation detecting means is mounted on the imaging element mounting portion with the direction of the radiation irradiating axis thereof substantially aligned with the longitudinal direction of the extending/contracting portion.

Further, in the case that the imaging element mounting portion of the first radiation imaging apparatus is capable of triaxial movement as described above, the guide mechanism may comprise a first guide portion which is fixed to the ceiling of a room and holds the extending/contracting portion such that it is movable in the Y direction, and a second guide portion which is engaged with the first guide portion and holds the extending/contracting portion such that it is movable in the X direction. In this case, it is desirable for the control means to be configured to drive the first and third driving sections in a state in which the one of the radiation source and the radiation detecting means is mounted on the imaging element mounting portion with the direction of the radiation irradiating axis thereof substantially aligned with the longitudinal direction of the extending/contracting portion.

Still further, in the case that the imaging element mounting portion of the first radiation imaging apparatus is capable of triaxial movement as described above, it is desirable for the control means to be configured to drive the first and third driving sections in a state in which one of the radiation source and the radiation detecting means is mounted on the imaging element mounting portion with the direction of the radiation irradiating axis thereof substantially aligned with one of the X direction and the Y direction.

Still yet further, in the case that the imaging element mounting portion of the first radiation imaging apparatus is capable of triaxial movement as described above, it is desirable for the control means to be configured to drive the second driving section in a state in which one of the radiation source and the radiation detecting means is mounted on the imaging element mounting portion with the direction of the radiation irradiating axis thereof substantially aligned with one of the X direction and the Y direction.

In addition, in the case that the imaging element mounting portion of the first radiation imaging apparatus is capable of triaxial movement as described above, it is desirable for the first radiation imaging apparatus to further comprise:

a rotatable holding mechanism, for holding the imaging element mounting portion rotatable about a substantially horizontal rotational axis with respect to the extending/contracting portion, provided between the extending/contracting portion and the imaging element mounting portion; and

a fourth driving section, for rotationally driving the imaging element mounting portion held by the rotatable holding mechanism; wherein:

the control means is configured to drive the fourth driving section to correct the positional shifting.

A second radiation imaging apparatus of the present invention is capable of preventing radiation imaging from being performed in the case that in plane positional shifting or an inaccurate SID is present, and comprises:

a radiation source, for emitting radiation toward a subject;

a radiation detecting means, for detecting the radiation which has passed through the subject;

an imaging element mounting portion, on which one of the radiation source and the radiation detecting means is mounted;

an extending/contracting portion, which is extensible and contractible in a substantially vertical Z direction, for holding the imaging element mounting portion;

a guide mechanism, for holding the extending/contracting portion such that the extending/contracting portion is movable in at least one of an X direction and a Y direction, which are substantially horizontal and perpendicularly intersect the direction of extension and contraction of the extending/contracting portion;

a horizontal movement driving section, for moving the extending/contracting portion along the guide mechanism;

a vertical movement driving section, for causing the extending/contracting portion to extend and contract;

display means;

an inclination angle sensor, for detecting the inclination of the longitudinal axis of the extending/contracting portion with respect to the direction of gravity; and

control means, for obtaining an amount of positional shifting of one of the radiation detecting means and the radiation source, which is mounted on the imaging element mounting portion, from a predetermined position, based on the inclination detected by the inclination angle sensor and the length of the extending/contracting portion, and for causing the display means to display information that represents the amount of positional shifting.

A third radiation imaging apparatus of the present invention is also capable of preventing radiation imaging from being performed in the case that in plane positional shifting or an inaccurate SID is present, and comprises:

a radiation source, for emitting radiation toward a subject;

a radiation detecting means, for detecting the radiation which has passed through the subject;

an imaging element mounting portion, on which one of the radiation source and the radiation detecting means is mounted;

an extending/contracting portion, which is extensible and contractible in a substantially vertical Z direction, for holding the imaging element mounting portion;

a guide mechanism, for holding the extending/contracting portion such that the extending/contracting portion is movable in at least one of an X direction and a Y direction, which are substantially horizontal and perpendicularly intersect the direction of extension and contraction of the extending/contracting portion;

a horizontal movement driving section, for moving the extending/contracting portion along the guide mechanism;

a vertical movement driving section, for causing the extending/contracting portion to extend and contract;

warning means;

an inclination angle sensor, for detecting the inclination of the longitudinal axis of the extending/contracting portion with respect to the direction of gravity; and

control means, for obtaining an amount of positional shifting of one of the radiation detecting means and the radiation source, which is mounted on the imaging element mounting portion, from a predetermined position, based on the inclination detected by the inclination angle sensor and the length of the extending/contracting portion, and for causing a warning to be issued by the warning means when the positional shifting is present.

Note that in each of the aforementioned radiation imaging apparatuses of the present invention, it is desirable for two inclination angle sensors to be provided, one mounted on the imaging element mounting portion and the other mounted on the guide mechanism. Alternatively, the inclination angle sensor may be mounted only on the imaging element mounting portion. Triaxial acceleration sensors may be employed as the inclination angle sensors.

It is desirable for the radiation imaging apparatuses according to the present invention to be configured such that the guide mechanism is provided on the ceiling of a room; and the extending/contracting portion is held by the guide mechanism such that it extends downward.

As described above, the first radiation imaging apparatus of the present invention is equipped with the inclination angle sensor, for detecting the inclination of the longitudinal axis of the extending/contracting portion with respect to the direction of gravity; and the control means, for obtaining an amount of positional shifting of one of the radiation detecting means and the radiation source, which is mounted on the imaging element mounting portion, from a predetermined position, based on the inclination detected by the inclination angle sensor and the length of the extending/contracting portion, and for driving at least one of the horizontal movement driving section and the vertical movement driving section in order to correct the positional shifting. Therefore, in plane positional shifting and inaccurate SID's between the radiation source and the radiation detecting means can be accurately corrected, without irradiating radiation.

A configuration may be adopted, wherein the imaging element mounting portion of the first radiation imaging apparatus is capable of triaxial movement, and the control means is configured to drive the first and second driving sections in a state in which the one of the radiation source and the radiation detecting means is mounted on the imaging element mounting portion with the direction of the radiation irradiating axis thereof substantially aligned with the longitudinal direction of the extending/contracting portion. In this case, in plane positional shifting between the radiation source, which is positioned to irradiate radiation in a substantially vertical direction, and the radiation detecting means, which is positioned substantially horizontally in order to receive the radiation, can be corrected.

A configuration may be adopted, wherein the imaging element mounting portion of the first radiation imaging apparatus is capable of triaxial movement, and the control means is configured to drive the third driving section in a state in which the one of the radiation source and the radiation detecting means is mounted on the imaging element mounting portion with the direction of the radiation irradiating axis thereof substantially aligned with the longitudinal direction of the extending/contracting portion. In this case, an inaccurate SID between the radiation source and the radiation detecting means, which are spaced apart in a substantially vertical direction, can be corrected.

A configuration may be adopted, wherein the imaging element mounting portion of the first radiation imaging apparatus is capable of triaxial movement, the guide mechanism comprises a first guide portion which is fixed to the ceiling of a room and holds the extending/contracting portion such that it is movable in the Y direction, and a second guide portion which is engaged with the first guide portion and holds the extending/contracting portion such that it is movable in the X direction; and the control means is configured to drive the first and third driving sections in a state in which the one of the radiation source and the radiation detecting means is mounted on the imaging element mounting portion with the direction of the radiation irradiating axis thereof substantially aligned with the longitudinal direction of the extending/contracting portion. In this case, the aforementioned in plane positional shifting and inaccurate SID's can be effectively preventable. Hereinafter, this point will be described in detail.

The first guide portion that holds the extending/contracting portion such that it is movable in the Y direction is directly fixed to the ceiling. Therefore, it is possible to prevent flexing of the first guide portion, by applying techniques such as increasing the number of points at which the first guide portion is fixed to the ceiling, employing a sturdy fixing structure, and the like. In contrast, it is necessary for the second guide portion that holds the extending/contracting portion such that it is movable in the X direction to be relatively movable with respect to the first guide portion. Therefore, it is difficult to apply the aforementioned techniques, resulting in the second guide portion becoming likely to flex. Accordingly, in the structure described above, positional inaccuracies of the imaging element mounting portion become likely to occur in the X direction and the Z direction in cases that a subject is imaged in an upright state and in cases that a subject is imaged in a supine state. Therefore, if the control means is configured to drive the first and third driving sections, the aforementioned in plane positional shifting and inaccurate SID's can be effectively preventable.

Further, a configuration may be adopted, wherein the imaging element mounting portion of the first radiation imaging apparatus is capable of triaxial movement, and the control means is configured to drive the first and third driving sections in a state in which one of the radiation source and the radiation detecting means is mounted on the imaging element mounting portion with the direction of the radiation irradiating axis thereof substantially aligned with one of the X direction and the Y direction. In this case, in plane positional shifting between the radiation source, which is positioned to irradiate radiation in a substantially horizontal direction, and the radiation detecting means, which is positioned substantially vertically in order to receive the radiation, can be corrected.

Still further, a configuration may be adopted, wherein the imaging element mounting portion of the first radiation imaging apparatus is capable of triaxial movement, and the control means is configured to drive the second driving section in a state in which one of the radiation source and the radiation detecting means is mounted on the imaging element mounting portion with the direction of the radiation irradiating axis thereof substantially aligned with one of the X direction and the Y direction. In this case, an inaccurate SID between the radiation source and the radiation detecting means, which are spaced apart in a substantially horizontal direction, can be corrected.

In addition, a configuration may be adopted, wherein the imaging element mounting portion of the first radiation imaging apparatus is capable of triaxial movement, and the first radiation imaging apparatus further comprises:

a rotatable holding mechanism, for holding the imaging element mounting portion rotatable about a substantially horizontal rotational axis with respect to the extending/contracting portion, provided between the extending/contracting portion and the imaging element mounting portion; and

a fourth driving section, for rotationally driving the imaging element mounting portion (and consequently, the radiation source or the radiation detecting means) held by the rotatable holding mechanism; wherein:

the control means is configured to drive the fourth driving section to correct the positional shifting. In this case, in plane positional shifting and inaccurate SID's between the radiation source and the radiation detecting means can be corrected.

Meanwhile, the second radiation imaging apparatus of the present invention is equipped with: the display means; the inclination angle sensor, for detecting the inclination of the longitudinal axis of the extending/contracting portion with respect to the direction of gravity; and the control means, for obtaining an amount of positional shifting of one of the radiation detecting means and the radiation source, which is mounted on the imaging element mounting portion, from a predetermined position, based on the inclination detected by the inclination angle sensor and the length of the extending/contracting portion, and for causing the display means to display information that represents the amount of positional shifting. Therefore, in the case that in plane positional shifting or inaccuracies in SID's are present, an operator can recognize this fact by viewing the display. Then, the in plane positional shifting and the inaccurate SID may be corrected, by moving the radiation source or the radiation detecting means manually, for example, based on the display.

The third radiation imaging apparatus of the present invention is equipped with: the warning means; the inclination angle sensor, for detecting the inclination of the longitudinal axis of the extending/contracting portion with respect to the direction of gravity; and the control means, for obtaining an amount of positional shifting of one of the radiation detecting means and the radiation source, which is mounted on the imaging element mounting portion, from a predetermined position, based on the inclination detected by the inclination angle sensor and the length of the extending/contracting portion, and for causing a warning to be issued by the warning means when the positional shifting is present. Therefore, in the case that in plane positional shifting or inaccuracies in SID's are present, an operator can recognize this fact by the warning being issued. Accordingly, radiation imaging being performed while the in plane positional shifting or inaccuracies in SID's being present can be prevented.

A configuration may be adopted, wherein: the guide mechanism is provided on the ceiling of a room; and the extending/contracting portion is held by the guide mechanism such that it extends downward. In this case, in plane positional shifting and inaccuracies in SID's become more likely to occur due to the reasons described above. Therefore, the advantageous effects of correcting the in plane positional shifting and inaccuracies in SID's or preventing radiation imaging from being performed in states that they are present will become more effective.

### BRIEF DESCRIPTION OF THE DRAWINGS

FIG. 1 is a perspective view that illustrates the entirety of a radiation imaging apparatus according to an embodiment of the present invention.

FIG. 2 is a magnified perspective view of a portion of the radiation imaging apparatus of FIG. 1.

FIG. 3 is a block diagram that illustrates the electrical construction of the radiation imaging apparatus of FIG. 1.

FIG. 4 is a side view that illustrates the radiation imaging apparatus of FIG. 1 in a state when imaging is being performed.

FIG. 5 is a side view that illustrates the radiation imaging apparatus of FIG. 1 in another state when imaging is being performed.

FIG. 6 is a diagram that illustrates the problems associated with the radiation imaging apparatus of FIG. 1.

FIG. 7 is a side view that illustrates the main parts of the radiation imaging apparatus of FIG. 1.

FIG. 8 is a front view that illustrates the main parts of the radiation imaging apparatus of FIG. 1.

FIG. 9 is a flow chart that illustrates the steps of an example of a positional shifting correcting process performed by the radiation imaging apparatus of FIG. 1.

FIG. 10 is a flow chart that illustrates the steps of another example of a positional shifting correcting process performed by the radiation imaging apparatus of FIG. 1.

FIG. 11 is a side view that illustrates the main parts of the radiation imaging apparatus of FIG. 1.

FIG. 12 is a front view that illustrates the main parts of the radiation imaging apparatus of FIG. 1.

FIG. 13 is a flow chart that illustrates the steps of still another example of a positional shifting correcting process performed by the radiation imaging apparatus of FIG. 1.

FIG. 14 is a flow chart that illustrates the steps of still yet another example of a positional shifting correcting process performed by the radiation imaging apparatus of FIG. 1.

FIG. 15 is a side view that illustrates the main parts of the radiation imaging apparatus of FIG. 1.

FIG. 16 is a flow chart that illustrates the steps of another example of a positional shifting correcting process performed by the radiation imaging apparatus of FIG. 1.

FIG. 17 is a flow chart that illustrates the steps of yet another example of a positional shifting correcting process performed by the radiation imaging apparatus of FIG. 1.

FIG. 18 is a perspective view that illustrates an example of an inclination angle sensor.

FIG. 19 is a perspective view that illustrates another radiation imaging apparatus to which the present invention is applied.

FIG. 20 is a perspective view that illustrates yet another radiation imaging apparatus to which the present invention is applied.

FIG. 21 is a perspective view that illustrates still yet another radiation imaging apparatus to which the present invention is applied.

### DESCRIPTION OF THE PREFERRED EMBODIMENTS

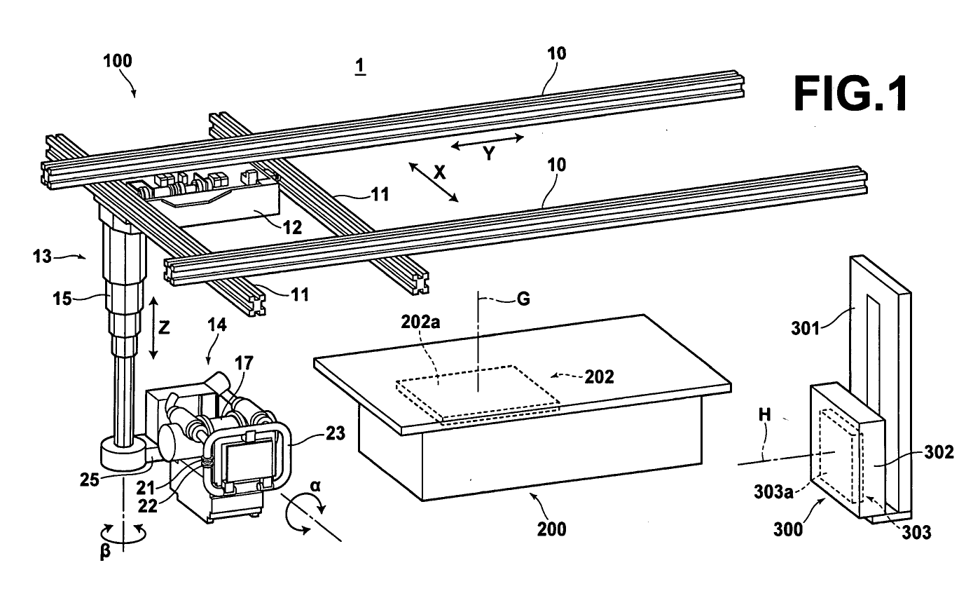

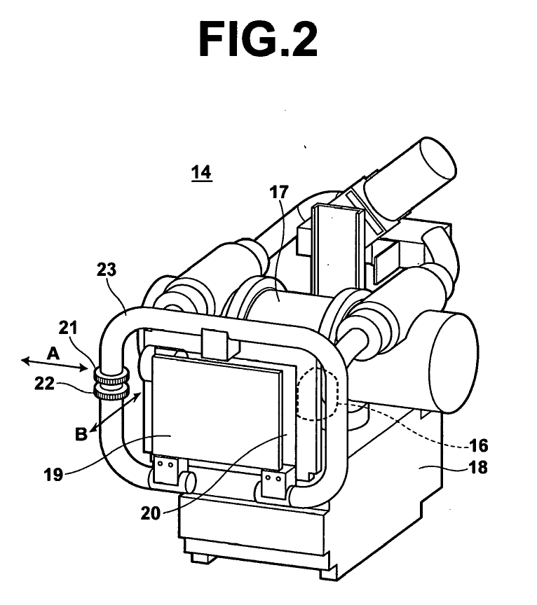

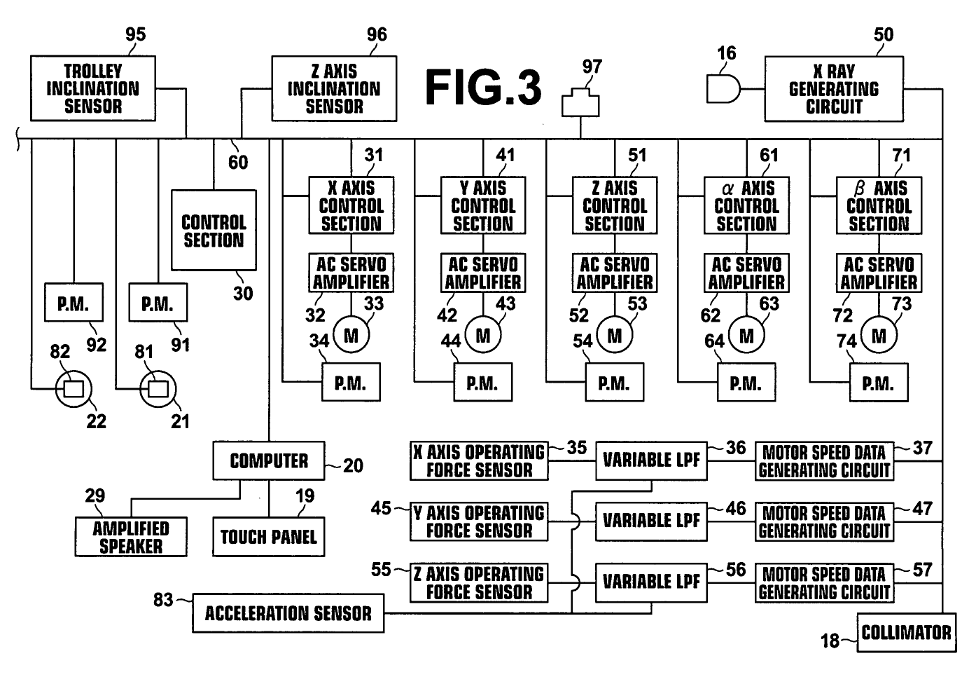

Hereinafter, embodiments of the present invention will be described in detail with reference to the attached drawings. FIG. 1 and FIG. 2 are perspective views that illustrate the entirety and a portion of a radiation imaging apparatus 1 according to a first embodiment of the present invention, respectively. FIG. 3 is a block diagram that illustrates the electrical construction of the radiation imaging apparatus 1.

As illustrated in FIG. 1, the radiation imaging apparatus 1 is constituted by: a ceiling runner unit 100, a supine imaging table 200, for imaging subjects in supine states, and an upright imaging base 300, for imaging subjects in upright states.

The ceiling runner unit 100 is constituted by: a pair of Y axis rails 10 and 10 that extend in a Y direction and are fixed to the ceiling of a hospital room parallel to each other; a pair of X axis rails 11 and 11 that extend in a horizontal direction perpendicular to the Y axis rails; a runner trolley 12 which is capable of moving along the X axis rails 11 and 11, and imparts driving force to wheels (not shown) which are mounted to each of the X axis rails 11 and engage with the Y axis rail 10, to enable the X axis rails 11 and 11 to move along the Y axis rails 10 and 10; a tube elevating portion 13, which is mounted on the runner trolley 12 such that it extends downward therefrom; and an operating block 14, which is mounted at the vicinity of the lower end of the X ray tube elevating portion, as an imaging element mounting portion.

The tube elevating portion 13 is equipped with a telescoping mechanism 15, in which a plurality of coaxial cylindrical members having different sizes are combined. The length of the telescoping mechanism is variable in the vertical direction, by being driven by a driving mechanism which is provided in the runner trolley 12. Note that in the first embodiment, the vertical direction is designated as a Z direction.

The supine imaging table is equipped with: a bed 201, and a solid state radiation detector 202, which is provided beneath the bed 201 such that a radiation detecting surface 202a thereof faces upward. Note that the radiation irradiation axis direction, that is, the direction in which a line G normal to the radiation detecting surface 202a extends, of the solid state radiation detector 202 provided in this manner is the vertical direction (the Z direction).

Meanwhile, the upright imaging base 300 is equipped with: a guide portion 301; an elevating base 302, which is movable in the vertical direction along the guide portion 301; and a solid state radiation detector 303, which is provided within the elevating base 302 such that a radiation detecting surface 303a thereof faces sideways. Note that the radiation irradiation axis direction, that is, the direction in which a line G normal to the radiation detecting surface 302a extends, of the solid state radiation detector 303 provided in this manner is the horizontal direction (the Y direction).

Next, the operating block 14 will be described in detail with reference to FIG. 2. The operating block 14 is equipped with: an X ray tube 16, for emitting X rays as an example of radiation toward subjects; a tube holding section 17, for holding the X ray tube 16; a collimator 18, for controlling the beam spread direction and the like of the X rays emitted from the X ray tube 16; a computer 20 equipped with a color touch panel 19 that functions as a display means as well as an input/output interface; a handle 23 constituted by rod shaped members, for moving and changing the orientation of the operating block 14; and a discoid first dial 21 and a discoid second dial 22, which are mounted on a portion of the handle 23 such that the central axes thereof are aligned with the longitudinal axis of the handle 23.

The first dial 21 and the second dial 22 are both rotatable in both directions about the central axes thereof, and are provided such that they are arranged in the direction of the central axes thereof. In the first embodiment, the dials 21 and 22 are configured to function as fine adjusting dials, for finely adjusting the amount of movement of the operating block 14 (that is, the X ray tube 16).

As illustrated in FIG. 1, the operating block 14 having the construction described above is mounted onto the lower end of the tube elevating portion via a rotatable holding portion 25. The rotatable holding portion 25 holds the operating block 14 such that it is rotatable in the α direction and the β direction illustrated in FIG. 1 with respect to the tube elevating portion 13. Here, the β direction is a rotational direction having an axis that extends in the Z direction as its center of rotation, and the α direction is a rotational direction having an axis that extends in the horizontal direction (the orientation of which varies according to the rotational position of the operating block 14 in the β direction) as its center of rotation.

Next, the electrical construction of the radiation imaging apparatus 1 will be described with reference to FIG. 3. A servo motor 33, for rotationally driving wheels (not shown) that cause the aforementioned runner trolley 12 (refer to FIG. 1) to move along the X axis rails 11 and 11 in the forward and reverse directions; a servo motor 43, for driving the wheels (not shown) that cause the X axis rails 11 and 11 to move along the Y axis rails 10 and 10; and a servo motor 53, for causing the telescoping mechanism 15 to extend and contract, thereby raising and lowering the tube elevating portion 13, are provided within the runner trolley 12. The amount and direction of drive of each of the servo motors 33, 43, and 53 are controlled by an X axis control section 31, a Y axis control section 41, and a Z axis control section 51 via AC servo amplifiers 32, 42, and 52, respectively. The operations of the control sections 31, 41, and 51 are controlled by a control section 30 connected thereto via a control wire 60.

In addition, potentiometers 34, 44, and 54 are provided to detect the amount and direction of drive of each of the servo motors 33, 43, and 53, that is, the amount and direction of movement of the operating block 14 in the X, Y, and Z directions. The outputs of the potentiometers 34, 44, and 54 are input to the X axis control section 31, the Y axis control section 41, the Z axis control section 51, and the control section 30.

Note that in the first embodiment, a first driving section, which is a horizontal movement driving section, is constituted by the X axis control section 31, the AC servo amplifier 32, and the servo motor 33. A second driving section, which is a horizontal movement driving section, is constituted by the Y axis control section 41, the AC servo amplifier 42, and the servo motor 43. A third driving section, which is a vertical movement driving section, is constituted by the Z axis control section 51, the AC servo amplifier 52, and the servo motor 53.

Meanwhile, a servo motor 63, for rotating the operating block 14 (refer to FIG. 1) in the α direction, and a servo motor 73, for rotating the operating block 14 in the β direction, are provided within the operating block 14. The amount and direction of drive of each of the servo motors 63 and 73 are controlled by an α axis control section 61 and a β axis control section 71 via AC servo amplifiers 62 and 72, respectively. The operations of the control sections 61 and 71 are controlled by the control section 30 connected thereto via the control wire 60. Note that in the first embodiment, a fourth driving section is constituted by the α axis control section 61, the β axis control section 71, the AC servo amplifiers 62 and 72, and the servo motors 63 and 73.

In addition, potentiometers 64 and 74 are provided to detect the amount and direction of drive of each of the servo motors 63 and 73, that is, the amount and direction of rotation of the operating block 14 in the α and β directions. The outputs of the potentiometers 64 and 74 are input to the α axis control section 61, the β axis control section 71, and the control section 30.

The computer 20 (refer to FIG. 1) is connected to the control section 30 via the control wire 60. The color touch panel 19 illustrated in FIG. 1 and an amplified speaker 29, for issuing audio guidance and alarms, are connected to the computer 20.

As will be described later, the operating block 14 is capable of being moved to desired positions by an operator moving the operating block 14 in the X, Y, and Z directions while gripping the handle 23, in addition to being moved automatically. An X axis operating force sensor 35, a Y axis operating force sensor 45, and a Z axis operating force sensor 55, for detecting operating forces in each of the X, Y, and Z directions during such manual movement, are provided. The outputs of the operating force sensors 35, 45, and 55 are input to motor speed data generating circuits 37, 47, and 57 via variable LPF's (Low Pass Filters) 36, 46, and 56, respectively. The motor speed data generated by the motor speed generating circuits 37, 47, and 57 are input to the control section 30 via the control wire 60.

An acceleration sensor 83, for detecting acceleration which is applied when the operating block 14 is moved, is mounted onto a portion of the operating block 14. The output of the acceleration sensor 83 is input to the variable LPF's 36, 46, and 56.

The X ray tube 16 illustrated in FIG. 1 emits X rays when driven by an X ray generating circuit 50. The operations of the X ray generating circuit 50 and the collimator 18 (refer to FIG. 1) are controlled by the control section 30 via the control wire 60. A tube switch 97 is connected to the control section 30 via the control wire 60, and trigger signals that cause the X ray tube 16 to emit X rays are input from the tube switch 97 to the X ray generating circuit 50.

Potentiometers 91 and 92, for detecting the amount and direction of rotation of each of the first dial 21 and the second dial 22, are provided in the operating block 14. The outputs of the potentiometers 91 and 92 are input to the control section 30 via the control wire 60. In the first embodiment, a fine adjustment mode, in which the operating block 14 is moved in fine increments by the first dial 21, the potentiometer 91, the second dial 22, the potentiometer 92, and the control section 30, is executed. However, a detailed description of the fine adjustment mode will be omitted. In addition, the first dial 21 and the second dial 22 are formed by semitransparent members, for example, and LED units 81 and 82 for illuminating the dials are provided in the interiors thereof.

A trolley inclination sensor 95, which is a biaxial inclination sensor for detecting inclinations of the runner trolley 12 in the X direction (inclinations within an X-Z plane) and inclinations in the Y direction (inclinations within a Y-Z plane) is mounted on the runner trolley 12. A Z axis inclination sensor 96, which is a biaxial inclination sensor for detecting inclinations in the X direction and inclinations in the Y direction of the longitudinal axis of the tube elevating portion 13, is mounted in the vicinity of the lower end of the tube elevating portion 13. The outputs of the sensors 95 and 96 are input to the control section 30 via the control wire 60.

Note that the control wire 60 is connected to a main computer (not shown), and the main computer controls the supine imaging table 200, the upright imaging base 300, and the ceiling runner unit 100. However, this is not directly relevant to the present invention, and therefore, a detailed description will be omitted.

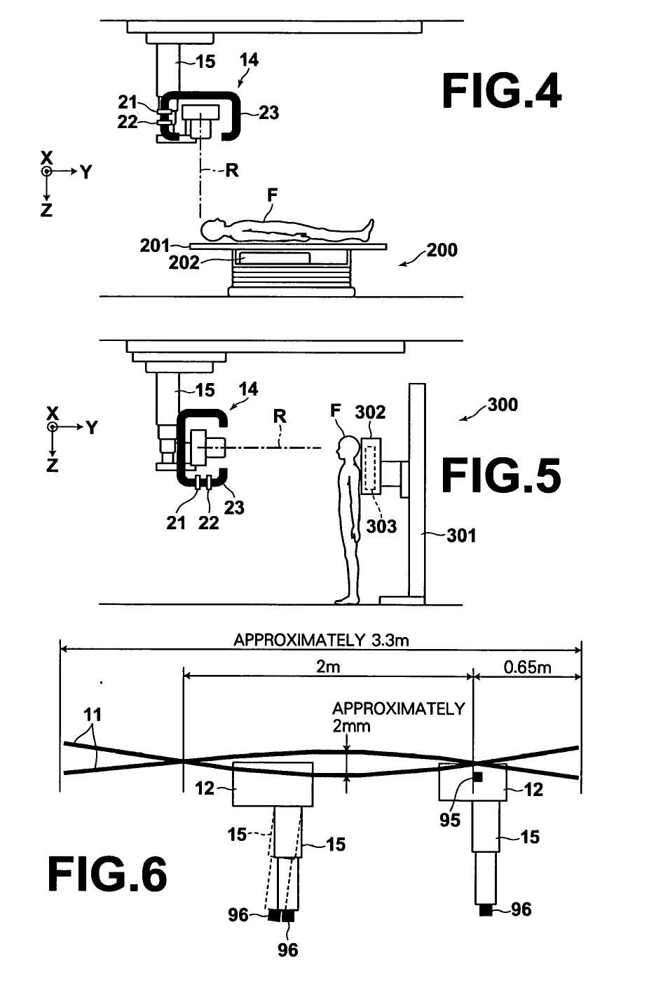

Hereinafter, the operation of the radiation imaging apparatus 1 having the above construction will be described. The radiation imaging apparatus 1 is capable of performing imaging that utilizes the supine imaging table 200 as illustrated in FIG. 4, and imaging that utilizes the upright imaging base 300 as illustrated in FIG. 5.

In the case illustrated in FIG. 4, a subject F is placed in a supine position on the bed 201. The operating block 14 is provided such that the X ray tube 16 (refer to FIG. 2) faces downward. The X ray tube 16 is driven by the tube switch 97 being operated in this state. Thereby, radiation which is emitted from the X ray tube 16 and passes through the subject F is detected by the solid state radiation detector 202, and signals that bear transmitted radiation image information of the subject F are obtained from the solid state radiation detector 202.

In the case illustrated in FIG. 5, a subject F is placed in an upright position in front of the elevating base 302. The operating block 14 is provided such that the X ray tube 16 (refer to FIG. 2) faces sideways. The X ray tube 16 is driven by the tube switch 97 being operated in this state. Thereby, radiation which is emitted from the X ray tube 16 and passes through the subject F is detected by the solid state radiation detector 303, and signals that bear transmitted radiation image information of the subject F are obtained from the solid state radiation detector 303.

Note that when the orientation of the operating block 14 is changed from the state illustrated in FIG. 4 to the state illustrated in FIG. 5, the handle is gripped to rotate the operating block 14 manually in the α direction of FIG. 1, or the operating block 14 is rotated by being driven by the servo motor 63.

In order to perform radiation imaging as described above, it is necessary to place the X ray tube 16 at a predetermined position with respect to the solid state radiation detector 202 or 303. Hereinafter, movement of the X ray tube 16 to the predetermined position will be described.

The operating block 14 that holds the X ray tube 16 is movable in the X, Y, and Z direction by being driven by the servo motors 33, 43, and 53. In the case that the operating block 14 is to be moved in this manner, positional data for the X ray tube 16 is input via the color touch panel 19, for example. Then, the amounts and directions in which the servo motors 33, 43, and 53 are to be driven are determined by the control section 30. Thereafter, data regarding the amounts and directions are input to the X axis control section 31, the Y axis control section 41, and the Z axis control section 51.

The X axis control section 31, the Y axis control section 41, and the Z axis control section 51 control the amounts and directions in which the servo motors 33, 43, and 53 are driven. As a result, the operating block 14, that is, the X ray tube 16, is set at desired positions in the X, Y, and Z directions. The positions in the X, Y, and Z directions set in this manner are detected by the potentiometers 34, 44, and 54, and the detected positional data are displayed on the color touch panel 19. Accordingly, the operator can cause the X ray tube 16 to be placed at the desired positions while confirming the display.

The mode of movement of the X ray tube 16 described above will be referred to hereinafter as a “rough movement mode” Note that the position of the X ray tube 16 is defined by two dimensional coordinates having the center position of the solid state radiation detector 202 or the 303 that the X ray tube 16 faces as the origin, or the like. In addition, a laser beam may be emitted from an X ray emitting opening or from the collimator 18 toward the bed 201 of the supine imaging table 200 or the elevating base 302 of the upright imaging base 300 prior to driving the X ray tube for radiation imaging, to confirm the position of the X ray tube 16.

Alternatively, it is possible to move the X ray tube 16 in a “PA mode” (Power Assist mode). In the PA mode, the driving forces of the servo motors 33, 43, and 53 assist manual movement of the operating block 14 by the operator. That is, in this case, the operator grips the handle 23 (refer to FIG. 2) with one hand, and moves the operating block 14 in a desired direction from among the X, Y, and Z directions, or a combination of the X, Y, and Z directions.

At this time, the X axis operating force sensor 35, the Y axis operating force sensor 45, and the Z axis operating force sensor 55 illustrated in FIG. 3 sense the direction and intensity of the operating force applied in each of the X, Y, and Z directions. The outputs of the operating force sensors 35, 45, and 55 are input to the motor speed data generating circuits 37, 47, and 57 via the variable LPF's 36, 46, and 56, respectively. The motor speed data generating circuits 37, 47, and 57 basically generate motor speed data that commands higher speeds as the operating force is greater. The control section 30 receives the motor speed data, and inputs command signals to rotate the servomotors 33, 43, and 53 at rotating speeds corresponding to the speed data, and in the directions corresponding to the directions of the operating forces to the X axis control section 31, the Y axis control section 41, and the Z axis control section 51.

When the operator confirms that the X ray tube 16 has reached the desired position in the same manner as that in the rough movement mode described previously, the operator ceases manipulating the operating block 14 to move it. At this time, the motor speed data generated by the motor speed data generating circuits 37, 47, and 57 indicate speeds of “0”, and the operating block 14 becomes stationary. Note that the acceleration sensor 83 illustrated in FIG. 3 detects the degree of acceleration of the operating block 14 while it is being moved manually, and changes the properties of the variable LPF's 36, 46, and 56 according to the detected degree of acceleration.

In the construction described above, there are cases in which the telescoping mechanism 15 that constitutes the tube elevating portion 13 becomes inclines with respect to the vertical axis, for the reasons described previously. If an inclination of the telescoping mechanism 15 is present, accurate placement of the X ray tube 16 with respect to the solid state radiation detector 202 or the solid state radiation detector 303 (often, a position at which a radiation irradiating axis R faces the center position of the radiation detectors) by the aforementioned rough movement mode or the PA mode may not be possible. In addition, inaccuracies in the SID may occur. Hereinafter, correction to correct these deficiencies in positioning will be described.

First, the basic configuration of the correction will be described with reference to FIG. 6. FIG. 6 is a diagram that schematically illustrates how the X axis rails 11 are bent, along with the dimensions thereof. It is often the case that the X axis rails 11, which have lengths of approximately 3 m, have curvatures of approximately 2 mm at portions thereof. That is, the X axis rails 11 are basically maintained in a substantially parallel state at the portions thereof which are held by the Y axis rails 10 (the portions at which the two X axis rails intersect in FIG. 6). However, flexing is likely to occur at the other portions thereof. In addition, the X axis rails 11 are held onto a first Y axis rail 10 via the movement mechanism for moving in the Y axis direction, which results in a solid hold with no margin of error. In contrast, it is often the case that the X axis rail is held so as to be freely slidable with respect to a second Y axis rail 10. As a result, the X axis rails 11 become more likely to be distorted at positions toward the second Y axis rail 10.

As a result, the runner trolley 12 which is held by the X axis rails substantially does not become inclined at all at the portions at which the X axis rails 11 are held by the Y axis rails 10, as illustrated toward the right side of FIG. 6. However, the runner trolley 12 is likely to become inclined at other portions, as indicated by the broken lines toward the left side of FIG. 6. As a consequence, the telescoping mechanism 15, which is supported by the telescoping mechanism 15 also becomes inclined. In addition, there are cases in which the telescoping mechanism 15 becomes inclined with respect to the runner trolley 12 itself.

The inclination of the telescoping mechanism 15 include inclinations in the X direction (inclinations within an X-Z plane) and inclinations in the Y direction (inclinations within a Y-Z plane). Such inclinations are detected by the trolley inclination sensor 95 and the Z axis inclination sensor 96. The outputs of the sensors 95 and 96 are input to the control section 30 via the control wire 60. The control section 30 obtains the length of the telescoping mechanism 15 from the output of the potentiometer 54, more specifically, the length from the Y axis rails 10 to the focal point position of the X ray tube 16. Then, the control section calculates an amount of positional shifting in both the X direction and the Y direction of the focal point position of the X ray tube 16 from a predetermined position, based on the angles detected by the sensors 95 and 96 and the length of the telescoping mechanism 15. The control section 30 then inputs drive control signals corresponding to the calculated amount of positional shifting to the X axis control section 31 and the Y axis control section 41. Thereby, the servo motors 33 and 43 rotate for amounts according to the drive control signals, and the runner trolley 12, that is, the X ray tube 16, moves in the X and Y directions to correct the positional shifting. In the case of the imaging operation illustrated in FIG. 4, positional shifting of the X ray tube 16 with respect to the solid state radiation detector 202 in the X direction and the Y direction is corrected.

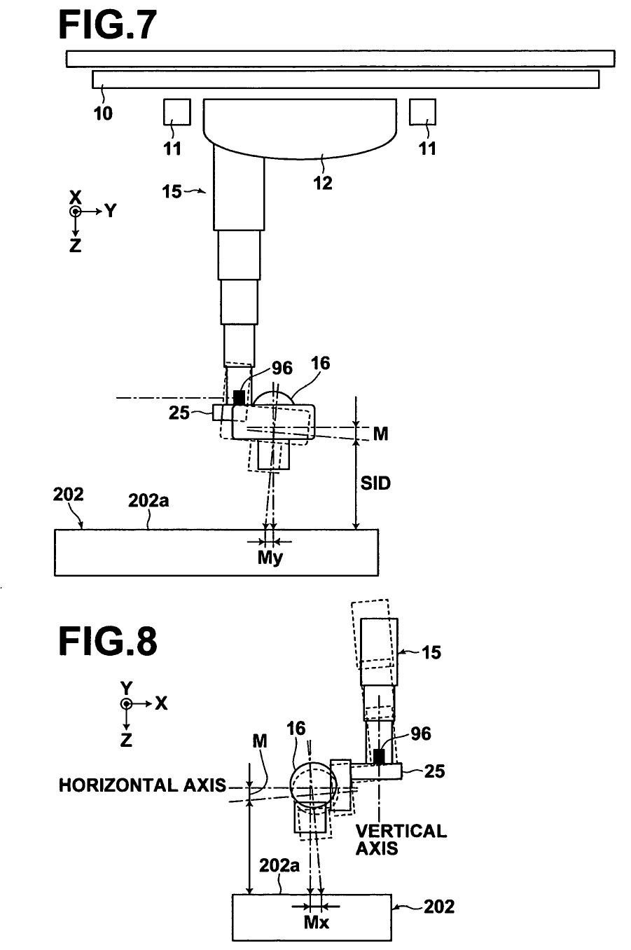

Next, correction of positional shifting for cases which are illustrated in FIG. 7 and FIG. 8 will be described. This example is for a case in which imaging is performed in the manner illustrated in FIG. 4. Here, the vicinity of the lower end of the telescoping mechanism 15 is inclined. An inclination is present in the Y direction as illustrated in the side view of FIG. 7, and an inclination is present in the X direction as illustrated in the front view of FIG. 8. In this case as well, the control section 30 controls the rotation of the servo motors 33 and 43 in the same manner as that described above. Thereby, the runner trolley 12, that is, the X ray tube 16, is moved to correct the amount of positional shifting My in the Y direction illustrated in FIG. 7 and the amount of positional shifting Mx in the X direction illustrated in FIG. 8.

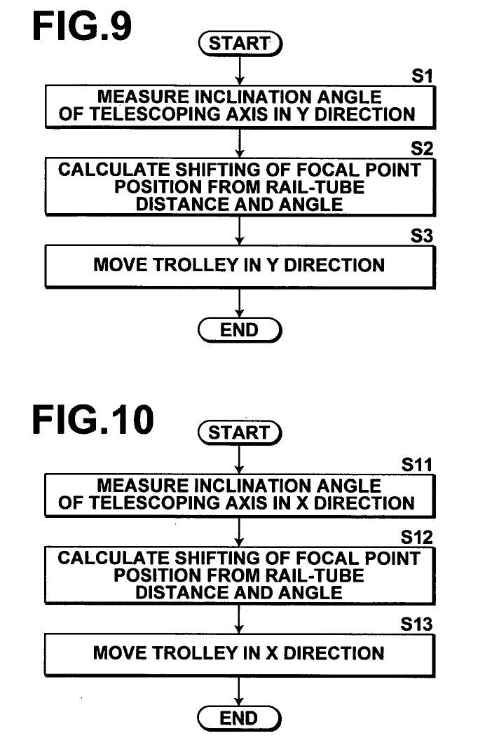

The basic flow of the correcting process for correcting the positional shifting in the Y direction is illustrated in steps S1 through S3 of the flow chart of FIG. 9. Meanwhile, the basic flow of the correcting process for correcting the positional shifting in the X direction is illustrated in steps S11 through S13 of the flow chart of FIG. 10.

Here, as illustrated in FIG. 7, the SID will become shifted from a desired value, due to the inclination of the telescoping mechanism 15. In this case, the desired SID value is a distance denoted by “SID+M” in FIG. 7. However, the actual SID value is “SID”, which is a shorter distance. The amount of shifting M can also be known from the angle of inclination in the Y direction detected by the Z axis inclination sensor 96, and the length of the telescoping mechanism 15 indicated by the output of the potentiometer 54. The control section 30 calculates the amount of shifting of the SID, and inputs a drive control signal corresponding to the calculated amount of shifting to the Z axis control section 51. Thereby, the servo motor 53 rotates for an amount according to the drive control signal, the telescoping mechanism 15, that is, the X ray tube 16, is raised or lowered to correct the amount of shifting, and the correct desired SID value is achieved.

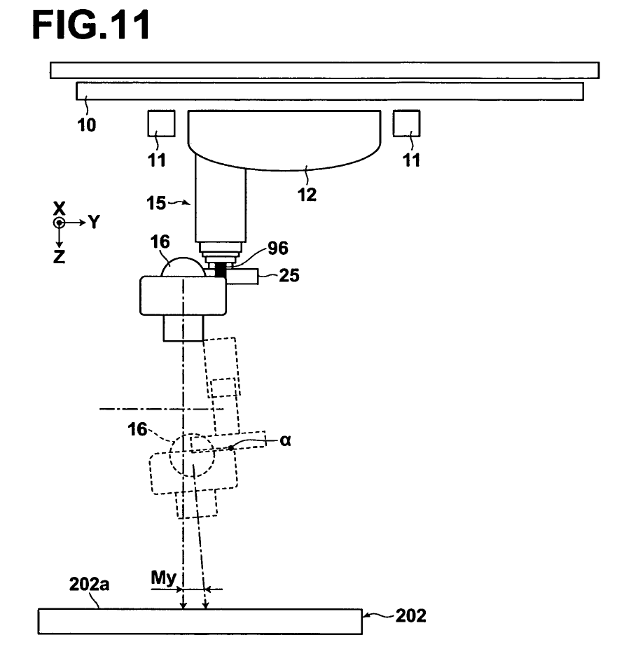

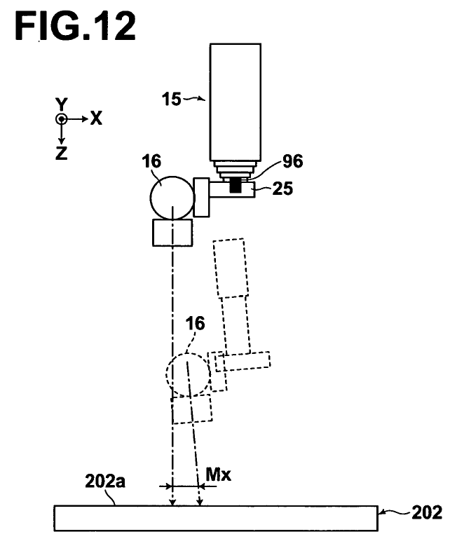

Next, correction of positional shifting for cases which are illustrated in FIG. 11 and FIG. 12 will be described. This example is also for a case in which imaging is performed in the manner illustrated in FIG. 4. Here, no positional shifting occurs when the telescoping mechanism 15 is in its shortest state, but the inclination of the telescoping mechanism 15 occurs as it extends. In this case as well, an inclination is present in the Y direction as illustrated in the side view of FIG. 11, and an inclination is present in the X direction as illustrated in the front view of FIG. 12. At this time, the control section 30 obtains the amount of extension of the telescoping mechanism 15 from the output of the potentiometer 54. Then, the control section 30 calculates the amount of positional shifting in both the X direction and the Y direction of the focal point position of the X ray tube 16 from a predetermined position, based on angles of inclination in the X direction and the Y direction detected by the sensors 95 and 96 and the length of the telescoping mechanism 15. The control section 30 then inputs drive control signals corresponding to the calculated amounts of positional shifting Mx and My to the X axis control section 31 and the Y axis control section 41. Thereby, the servo motors 33 and 43 rotate for amounts according to the drive control signals, and the runner trolley 12, that is, the X ray tube 16, moves in the X and Y directions to correct the positional shifting. Accordingly, positional shifting of the X ray tube 16 with respect to the solid state radiation detector 202 in the X direction and the Y direction is corrected.

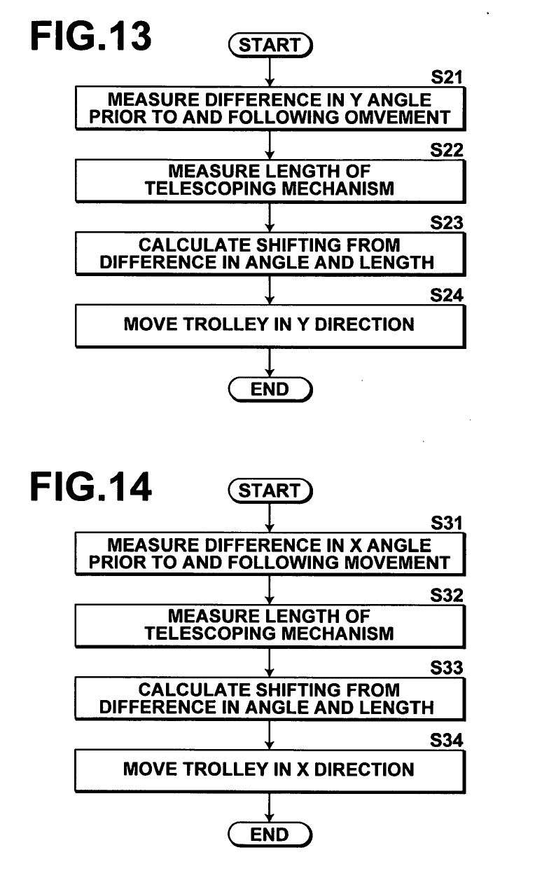

The basic flow of the correcting process for correcting the positional shifting in the Y direction at this time is illustrated in steps S21 through S23 of the flow chart of FIG. 13. Meanwhile, the basic flow of the correcting process for correcting the positional shifting in the X direction is illustrated in steps S31 through S33 of the flow chart of FIG. 14.

Note that in the state illustrated in FIG. 11, the horizontal axis of rotation in the α direction is at a position denoted by “α” in FIG. 11. Accordingly, it is also possible to correct the amount of shifting My in the Y direction by rotating the X ray tube 16 about this axis. In the case that correction is performed in this manner, the control section 30 obtains the amount of extension of the telescoping mechanism 15 from the output of the potentiometer 54. Then, the control section calculates an amount of rotation for the X ray tube 16 that can correct the amount of shifting My in the Y direction, based on the amount of extension and the angle of inclination in the Y direction detected by the Z axis inclination sensor 96. Thereafter, a control drive signal corresponding to the calculated amount of rotation is input to the α axis control section 61. Thereby, the servo motor 63 rotates for an amount according to the control drive signal to rotate the X ray tube 16, and the positional shifting My in the Y direction is corrected.

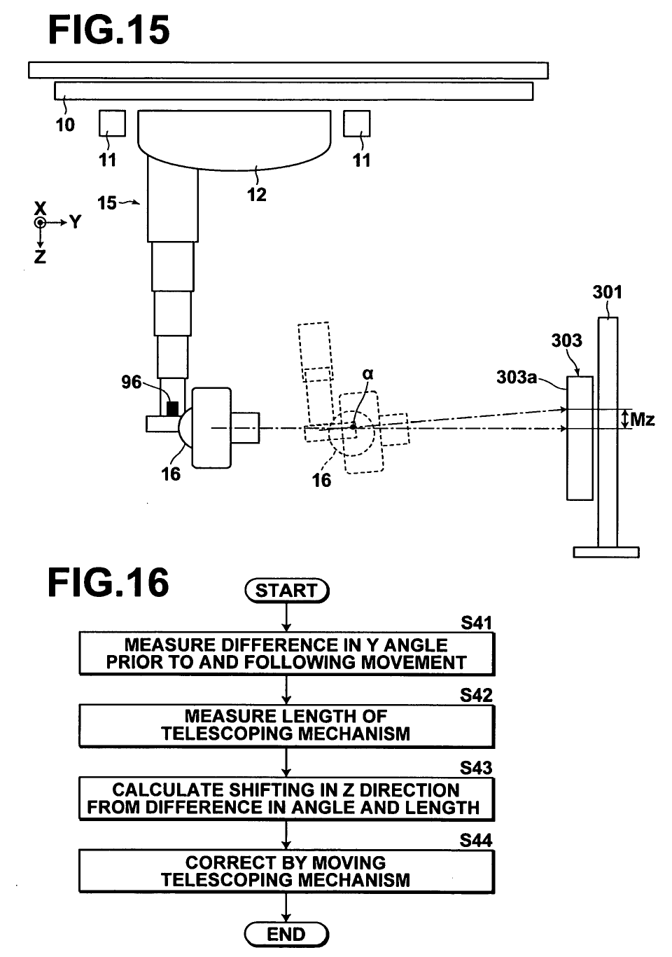

Next, correction of positional shifting for a case which is illustrated in FIG. 15 will be described. This example is for a case in which imaging is performed in the manner illustrated in FIG. 5. Here, the telescoping mechanism 15 becomes inclined as the runner trolley 12 moves along the Y axis rails 10. In this case, an inclination is present in the Z direction and an inclination is present in the X direction, as illustrated in FIG. 15. At this time, the control section obtains the length of the telescoping mechanism 15 based on the output of the potentiometer 54 and a difference in the angles of inclination in the X direction detected by the Z axis inclination sensor 96 and a difference in the angles of inclination in the Z direction prior to and following movement of the runner trolley 12. Next, the control section 30 calculates an amount of positional shifting Mz in the Z direction and an amount of positional shifting Mx in the X direction (not shown), based on the above values. Then, the control section 30 inputs drive control signals corresponding to the calculated amounts of positional shifting Mz and Mx to the Z axis control section 51 and the X axis control section 31. Thereby, the servo motors 53 and 33 rotate for amounts according to the drive control signals, to extend or contract the telescoping mechanism 15 and to move the runner trolley 12. The positional shifting Mz in the Z direction and the positional shifting Mx in the X direction are corrected in this manner.

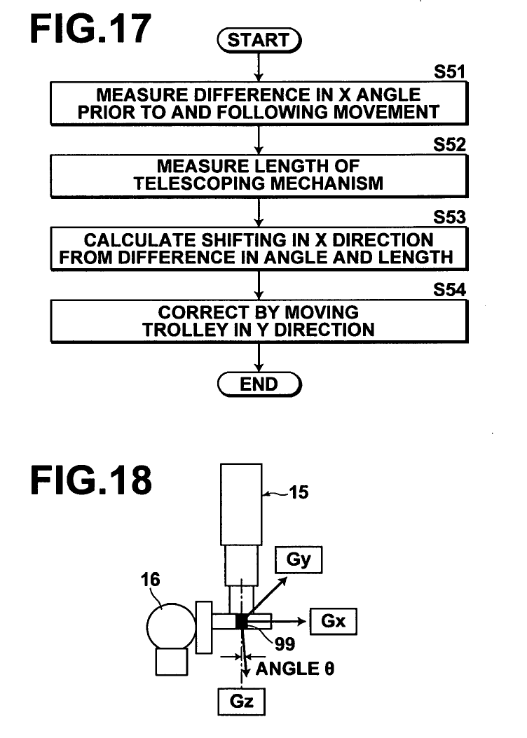

The basic flow of the correcting process for correcting the positional shifting in the Z direction is illustrated in steps S41 through S43 of the flow chart of FIG. 16. Meanwhile, the basic flow of the correcting process for correcting the positional shifting in the X direction is illustrated in steps S51 through S53 of the flow chart of FIG. 17.

In this case as well, the horizontal axis of rotation in the α direction is at a position denoted by “α” in FIG. 15. Accordingly, it is also possible to correct the positional shifting Mz in the Z direction by rotating the X ray tube 16 about this axis, in a manner similar to that described with reference to FIG. 11.

Note that triaxial acceleration sensors may be employed as the inclination angle sensors. FIG. 18 is a schematic diagram that illustrates a state in which a triaxial acceleration sensor 99 is mounted in the vicinity of the lower end of the telescoping mechanism 15. In the case that the triaxial acceleration sensor 99 is employed, the angle of inclination of the telescoping mechanism 15 can be obtained from the ratios among the degrees of acceleration in the three axial directions. For example, an angle of inclination θx in the X direction and an angle of inclination θy in the Y direction can be obtained by the following formulae:

θx=tan⁻¹(Gx/Gz)

θy=tan⁻¹(Gy/Gx)

wherein Gx is the degree of acceleration in the X direction, Gy is the degree of acceleration in the Y direction, and Gz is the degree of acceleration in the Z direction.

In the embodiment described above, in plane positional shifting and inaccuracies in SID's between the radiation source and the radiation detecting means were corrected. Alternatively, the amount of positional shifting may be displayed, or a warning that indicates that positional shifting is present may be issued, without performing correction. For example, with reference to the construction illustrated in FIG. 3, the amount of positional shifting obtained by the control section 30 may be displayed on the color tough panel 19, or a warning that indicates that positional shifting is present may be issued through the amplified speaker 29. in the former case, the amount of positional shifting which is notified by the display may be corrected by manual correcting operations.

In the case that the only the display or the issuance of the warning are performed as described above, wastes of time and resources that result from performing radiation imaging while in plane positional shifting or inaccurate SID's are present can be present.

A configuration in which the X ray tube 16 is provided in the operating block 14, which functions as an imaging element mounting portion, has been described. However, the present invention may be applied to a radiation imaging apparatus in which a radiation detecting means, such as a solid state radiation detector, is provided on the imaging element mounting portion to be moved. For example, in the case that the solid state radiation detector 202 illustrated in FIG. 1 is mounted onto the imaging element mounting portion, the facing direction of the solid state radiation detector 202 may be defined as the line G normal to the radiation detecting surface 202a, instead of the radiation irradiating axis R of the X ray tube 16.

In addition, the radiation detecting means is not limited to solid state radiation detectors. The present invention is applicable to radiation imaging apparatuses that employ the aforementioned stimulable phosphor sheets or silver salt X ray films as the radiation detecting means.

Further, the guide mechanism and the driving sections are not limited to the types described in the above embodiment, which are suspended from the ceiling of a room. The present invention may be applied to a guide mechanism and driving sections constituted by a robotic arm which is installed on the floor, for example. In the case that such a robotic arm is employed, there are cases in which a vertically extending member becomes inclined for a variety of reasons. Therefore, application of the present invention to such a configuration is sufficiently effective.

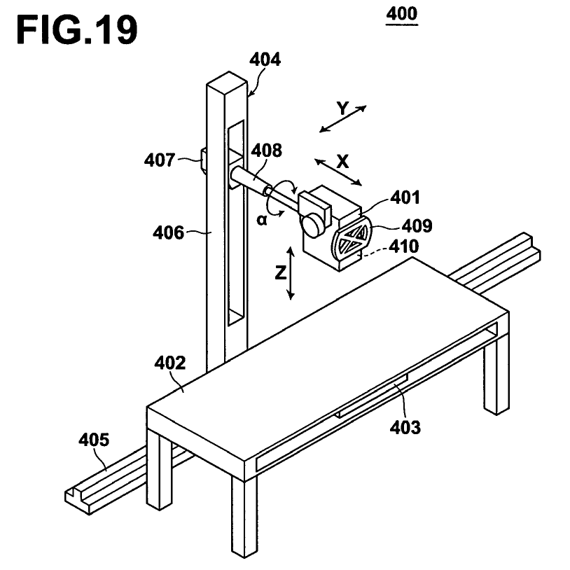

Further, the present invention may also be applied to radiation imaging apparatuses of the floor based type, in which an imaging element mounting portion is provided on a moving member that moves along rails provided on the floor of a room, and a radiation source or a radiation detecting means is mounted on the imaging element mounting portion. FIG. 19 is a diagram that illustrates an example of a floor based radiation imaging apparatus 400, to which the present invention is applied. The floor based radiation imaging apparatus 400 is equipped with: an operating block 401, on which a radiation source (not shown) is mounted; a supine imaging table 402, for supporting subjects in the supine position; a radiation detector 403 provided within the supine imaging table 402, for detecting radiation which is emitted from the radiation source and passes through the subjects; and a movement assisting section 404, for supporting the operating block 401 such that it is movable in the vertical direction (the Z direction) and the horizontal directions (the X and Y directions).

The movement assisting section 404 is equipped with fixed rails 405 which are provided on the floor surface; a movable column 406, which is capable of moving in the direction that the fixed rails 405 extend in (the Y direction) while engaged with the fixed rails 405; a vertical moving portion 407, which is movable in the vertical direction in a state in which it is engaged with the movable column 406; and a horizontally telescoping arm 408, which is mounted onto the vertical moving portion 407 and is capable of extending and contracting in the horizontal direction (the X direction) by telescopic motion. The operating block 401 is mounted at the tip of the horizontally telescoping arm 408 such that it is rotatable about the longitudinal axis thereof, that is, in the α direction. By rotating the operating block 401 in this manner, the direction of the radiation irradiating axis of the radiation source can be changed.

The floor based radiation imaging apparatus 400 is further equipped with: an operating handle 409, for manually moving the operating block 401; and a detecting section 410, for detecting operating forces which are applied to the operating handle 409 and outputs signals that indicate the intensities and directions of the operating forces.

The movable column 406, the vertical moving portion 407 and the horizontally telescoping arm 408 are driven by servo motors (not shown), to operate in the manners described above. These servo motors are driven in the same manners as the servo motors 33, 43, and 53 illustrated in FIG. 3, to assist manual movement of the operating block 401 by an operator in the X, Y, and Z directions.

Note that in addition to the fixed rails 405 which are provided on the floor surface, additional rails may be provided on a wall surface or on the ceiling. By causing these additional fixed rails to engage with the movable column 406, unnecessary positional displacement of the movable column 406 in directions other than the Y direction can be reduced.

The other components and the operation of the floor based radiation imaging apparatus 400 are basically the same as those of the radiation imaging apparatus 1 illustrated in FIGS. 1 through 4. In this type of apparatus as well, application of the present invention is effective, because the movable column 406 may become inclined.

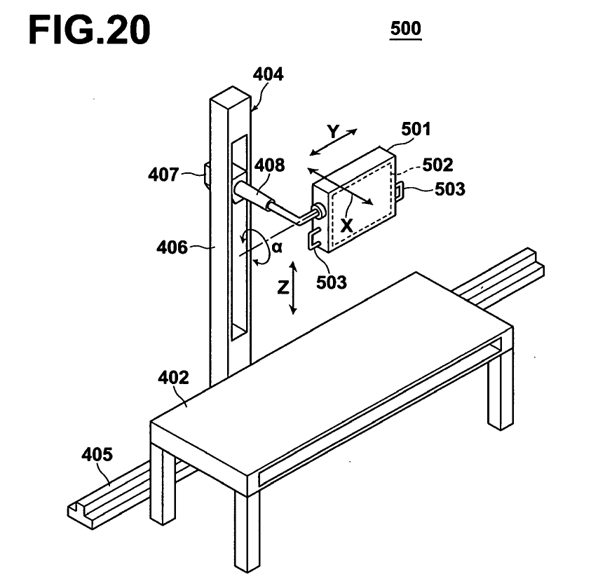

The radiation imaging apparatus described with reference to FIG. 19 is that in which the radiation source is mounted on the operating block 401, which is movable in the X, Y, and Z directions. Alternatively, the present invention may be applied to a floor based upright radiation imaging apparatus having a radiation detecting means mounted on the operating block. FIG. 20 is a diagram that illustrates an example of such a radiation imaging apparatus. Note that in FIG. 20, elements which are the same as those illustrated in FIG. 19 are denoted with the same reference numerals, and detailed descriptions thereof will be omitted insofar as they are not particularly necessary.

The radiation imaging apparatus 500 of FIG. 20 has a radiation detector 502 constituted by a solid state radiation detector mounted on an operating block 501, which is mounted to a vertical moving portion 407 via a horizontally telescoping arm 408. The operating block 501 is configured to be rotatable in a directions about a horizontally extending axis either manually or by drive means. In addition, operating handles 503, for moving the operating block 501 in the X, Y, and Z directions and for rotating the operating block 501 in the α directions, are fixed on the side surfaces thereof.

The radiation imaging apparatus 500 is capable of moving the operating block 501 to a position removed from a supine imaging table 402 (for example, a position toward the upper right of FIG. 20). The operating block 501 may be set to the orientation illustrated in FIG. 20 such that a detecting surface of the radiation detector 502 is vertical at this removed position. Then, a radiation source (not shown) which is suspended from the ceiling and is freely movable, for example, may be employed to perform radiation imaging of a subject in an upright state.

In addition, the operating block 501 may be moved to a position toward the side of the supine imaging table 402, and rotated 90° in the direction a from the orientation illustrated in FIG. 20 such that the detecting surface of the radiation detector 502 thereof is horizontal and faces upward. Thereafter, the operating block 501 may be lowered, then the horizontally telescoping arm 408 may be extended, to position the operating block 501 beneath the supine imaging table 402. In this state, radiation may be emitted toward a subject in a supine position on the supine imaging table 402 from the radiation source, and the radiation detector 502 may detect the radiation which passes through the subject, to perform radiation imaging of the subject in the supine position.

In this type of apparatus as well, application of the present invention is effective, because a movable column 406 may become inclined, as in the apparatus of FIG. 19.

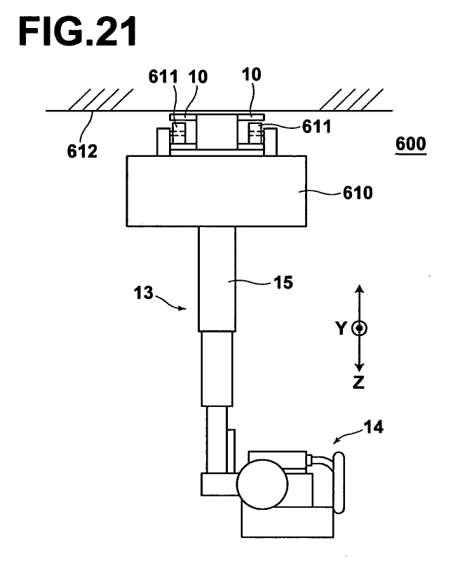

Embodiments, in which the imaging element mounting portion is movable in the X, Y, and Z directions that perpendicularly intersect each other, have been described above. However, the present invention may also be applied to a radiation imaging apparatus, in which an imaging element mounting portion is movable in two directions that perpendicularly intersect each other. FIG. 21 is a diagram that illustrates an example of such a radiation imaging apparatus.

The radiation imaging apparatus 600 illustrated in FIG. 21 differs from the radiation imaging apparatus 1 of FIG. 1 in that the X axis rails 11 are omitted, and that a runner trolley 610 is configured to be movable along Y axis rails 10 while engaged therewith. Note that the runner trolley 610 is engaged with the Y axis rails 10 by being suspended via drive wheels 611 that enable movement along the Y axis rails. That is, an operating block 14 of the radiation imaging apparatus 600 is movable only in the Y and Z directions.

The pair of Y axis rails 10 are formed to be comparatively long. However, because the rails are directly fixed to the ceiling 612 of a room, it is possible to prevent flexing of the Y axis rails 10, by applying techniques such as increasing the number of points at which the first guide portion is fixed to the ceiling, employing a sturdy fixing structure, and the like. In contrast, it is necessary for the X axis rails 11 of FIG. 1 to be relatively movable with respect to the Y axis rails 10. Therefore, it is difficult to apply the aforementioned techniques, resulting in the X axis rails 11 becoming likely to flex. By adopting a structure in which the X axis rails 11 are omitted, it becomes possible to prevent positional inaccuracies of an X ray tube 16 due to flexing of the X axis rails 11, particularly in the X and Z directions.

The advantageous effects of the present invention can be exhibited in the radiation imaging apparatus 600 as well, by adopting the electrical configuration illustrated in FIG. 3 except for the structures for movement in the X direction.

What is claimed is:

1. A radiation imaging apparatus, comprising:
a radiation source, for emitting radiation toward a subject;
a radiation detecting means, for detecting the radiation which has passed through the subject;
an imaging element mounting portion, on which one of the radiation source and the radiation detecting means is mounted;
an extending/contracting portion, which is extensible and contractible in a substantially vertical Z direction, for holding the imaging element mounting portion;
a guide mechanism, for holding the extending/contracting portion such that the extending/contracting portion is movable in at least one of an X direction and a Y direction, which are substantially horizontal and perpendicularly intersect the direction of extension and contraction of the extending/contracting portion;
a horizontal movement driving section, for moving the extending/contracting portion along the guide mechanism;
a vertical movement driving section, for causing the extending/contracting portion to extend and contract;
an inclination angle sensor, for detecting the inclination of the longitudinal axis of the extending/contracting portion with respect to the direction of gravity; and
control means, for obtaining an amount of positional shifting of one of the radiation detecting means and the radiation source, which is mounted on the imaging element mounting portion, from a predetermined position, based on the inclination detected by the inclination angle sensor and the length of the extending/contracting portion, and for driving at least one of the horizontal movement driving section and the vertical movement driving section in order to correct the positional shifting.

2. A radiation imaging apparatus as defined in claim 1, wherein:
a guide mechanism that holds the extending/contracting portion such that it is movable in only one of the X direction and the Y direction is employed.

3. A radiation imaging apparatus as defined in claim 1, wherein:
a guide mechanism that holds the extending/contracting portion such that it is movable in both the X direction and the Y direction is employed;
a first and second driving section that independently move the extending/contracting portion in the X direction and the Y direction respectively are provided as the horizontal movement driving section; and
a third driving section is provided as the vertical movement driving section.

4. A radiation imaging apparatus as defined in claim 3, wherein:
the control means is configured to drive the first and second driving sections in a state in which the one of the radiation source and the radiation detecting means is mounted on the imaging element mounting portion with the direction of the radiation irradiating axis thereof substantially aligned with the longitudinal direction of the extending/contracting portion.

5. A radiation imaging apparatus as defined in claim 3, wherein:
the control means is configured to drive the third driving section in a state in which the one of the radiation source and the radiation detecting means is mounted on the imaging element mounting portion with the direction of the radiation irradiating axis thereof substantially aligned with the longitudinal direction of the extending/contracting portion.

6. A radiation imaging apparatus as defined in claim 4, wherein:
the control means is configured to drive the third driving section in a state in which the one of the radiation source and the radiation detecting means is mounted on the imaging element mounting portion with the direction of the radiation irradiating axis thereof substantially aligned with the longitudinal direction of the extending/contracting portion.

7. A radiation imaging apparatus as defined in claim 3, wherein:
the guide mechanism comprises a first guide portion which is fixed to the ceiling of a room and holds the extending/contracting portion such that it is movable in the Y direction, and a second guide portion which is engaged with the first guide portion and holds the extending/contracting portion such that it is movable in the X direction; and
the control means is configured to drive the first and third driving sections in a state in which the one of the radiation source and the radiation detecting means is mounted on the imaging element mounting portion with the direction of the radiation irradiating axis thereof substantially aligned with the longitudinal direction of the extending/contracting portion.

8. A radiation imaging apparatus as defined in claim 3, wherein:
the control means is configured to drive the first and third driving sections in a state in which one of the radiation source and the radiation detecting means is mounted on the imaging element mounting portion with the direction of the radiation irradiating axis thereof substantially aligned with one of the X direction and the Y direction.

9. A radiation imaging apparatus as defined in claim 3, wherein:
the control means is configured to drive the second driving section in a state in which one of the radiation source and the radiation detecting means is mounted on the imaging element mounting portion with the direction of the radiation irradiating axis thereof substantially aligned with one of the X direction and the Y direction.

10. A radiation imaging apparatus as defined in claim 3, further comprising:
a rotatable holding mechanism, for holding the imaging element mounting portion rotatable about a substantially horizontal rotational axis with respect to the extending/contracting portion, provided between the extending/contracting portion and the imaging element mounting portion; and
a fourth driving section, for rotationally driving the imaging element mounting portion held by the rotatable holding mechanism; wherein:
the control means is configured to drive the fourth driving section to correct the positional shifting.

11. A radiation imaging apparatus, comprising:
a radiation source, for emitting radiation toward a subject;
a radiation detecting means, for detecting the radiation which has passed through the subject;
an imaging element mounting portion, on which one of the radiation source and the radiation detecting means is mounted;
an extending/contracting portion, which is extensible and contractible in a substantially vertical Z direction, for holding the imaging element mounting portion;
a guide mechanism, for holding the extending/contracting portion such that the extending/contracting portion is movable in at least one of an X direction and a Y direction, which are substantially horizontal and perpendicularly intersect the direction of extension and contraction of the extending/contracting portion;
a horizontal movement driving section, for moving the extending/contracting portion along the guide mechanism;
a vertical movement driving section, for causing the extending/contracting portion to extend and contract;
display means;
an inclination angle sensor, for detecting the inclination of the longitudinal axis of the extending/contracting portion with respect to the direction of gravity; and
control means, for obtaining an amount of positional shifting of one of the radiation detecting means and the radiation source, which is mounted on the imaging element mounting portion, from a predetermined position, based on the inclination detected by the inclination angle sensor and the length of the extending/contracting portion, and for causing the display means to display information that represents the amount of positional shifting.

12. A radiation imaging apparatus, comprising:
a radiation source, for emitting radiation toward a subject;
a radiation detecting means, for detecting the radiation which has passed through the subject;
an imaging element mounting portion, on which one of the radiation source and the radiation detecting means is mounted;
an extending/contracting portion, which is extensible and contractible in a substantially vertical Z direction, for holding the imaging element mounting portion;
a guide mechanism, for holding the extending/contracting portion such that the extending/contracting portion is movable in at least one of an X direction and a Y direction, which are substantially horizontal and perpendicularly intersect the direction of extension and contraction of the extending/contracting portion;
a horizontal movement driving section, for moving the extending/contracting portion along the guide mechanism;
a vertical movement driving section, for causing the extending/contracting portion to extend and contract;
warning means;
an inclination angle sensor, for detecting the inclination of the longitudinal axis of the extending/contracting portion with respect to the direction of gravity; and
control means, for obtaining an amount of positional shifting of one of the radiation detecting means and the radiation source, which is mounted on the imaging element mounting portion, from a predetermined position, based on the inclination detected by the inclination angle sensor and the length of the extending/contracting portion, and for causing a warning to be issued by the warning means when the positional shifting is present.

13. A radiation imaging apparatus as defined in claim 1, wherein:
two inclination angle sensors are provided, one mounted on the imaging element mounting portion and the other mounted on the guide mechanism.

14. A radiation imaging apparatus as defined in claim 1, wherein:
the inclination angle sensor is mounted only on the imaging element mounting portion.

15. A radiation imaging apparatus as defined in claim 1, wherein:
a triaxial acceleration sensor is employed as the inclination angle sensor.

16. A radiation imaging apparatus as defined in claim 1, wherein:
the guide mechanism is provided on the ceiling of a room; and
the extending/contracting portion is held by the guide mechanism such that it extends downward.

17. A radiation imaging apparatus as defined in claim 11, wherein:
the guide mechanism is provided on the ceiling of a room; and
the extending/contracting portion is held by the guide mechanism such that it extends downward.

18. A radiation imaging apparatus as defined in claim 12, wherein:
the guide mechanism is provided on the ceiling of a room; and
the extending/contracting portion is held by the guide mechanism such that it extends downward.
